(19) United States
(12) Patent Application Publication
(10) Pub. No.: US 2026/0236036 A1
(43) Pub. Date: Aug. 13, 2026

(54) METHOD AND APPARATUS FOR RESUMING CLEANING FROM INTERRUPTION POINT, AND AUTONOMOUS DEVICE AND STORAGE MEDIUM

(71) Applicant: SHENZHEN HANYANG TECHNOLOGY CO., LTD., Shenzhen (CN)

(72) Inventors: Yang HUANG, Shenzhen (CN); Chuwei ZHENG, Shenzhen (CN)

(21) Appl. No.: 19/652,166

(22) Filed: Apr. 20, 2026

Related U.S. Application Data
(63) Continuation of application No. PCT/CN2023/130119, filed on Nov. 7, 2023.

(30) Foreign Application Priority Data
Oct. 20, 2023 (CN) 202311375711.2

(51) Int. Cl. G05D 1/648; G05D 1/43

(52) U.S. Cl. CPC G05D 1/648; G05D 1/43

(57) ABSTRACT

Disclosed are a method for resuming cleaning after an interruption, an autonomous apparatus, and a storage medium. The method includes: in response to detecting an interruption event while an autonomous apparatus executes a cleaning operation on a preset region based on a preset path, acquiring an unexecuted path recorded by the autonomous apparatus at a last periodic recording time point; wherein the periodic recording time point refers to a time point at which the autonomous apparatus periodically updates and records the unexecuted path at a preset time interval; acquiring an interruption location on the preset path corresponding to the autonomous apparatus when the interruption event was detected; and after receiving a resumption instruction, controlling the autonomous apparatus to move to a target location and start, from the target location, a first cleaning resumption operation on the preset region based on the unexecuted path.

### CROSS-REFERENCE TO RELATED APPLICATIONS

This patent document claims priority to and benefits of PCT Application No. PCT/CN2023/130119 filed on Nov. 7, 2023, which claims priority to and benefits of Chinese Patent Application No. 202311375711.2, filed on Oct. 20, 2023, the entire contents of each of which are hereby incorporated herein by reference.

### TECHNICAL FIELD

This disclosure relates to the field of cleaning technology for autonomous apparatuses, and in particular, to a method and apparatus for resuming cleaning after an interruption, and an autonomous apparatus and a storage medium.

### BACKGROUND

Currently, autonomous apparatuses such as yard robots or snow-clearing robots may be used to reduce human workload and improve efficiency. During use, such autonomous apparatuses may stop working at an interruption location along a preset operating path due to various conditions, such as power failure, malfunction, or insufficient battery levels. It is observed that when attempting to resume operation after an interruption, the location of the autonomous apparatus may have shifted, or the device may return to an initial cleaning location of the preset operating path. Consequently, when resuming cleaning work, the workload may be increased due to repeated cleaning of regions that have already been cleaned (for example, some devices return to a starting location to restart a cleaning process), which may reduce cleaning efficiency or result in poor cleaning effects due to missed regions.

### SUMMARY

Embodiments of the present disclosure provide a method and apparatus for resuming cleaning after an interruption, an autonomous apparatus, and a storage medium, which may address technical issues of cleaning efficiency and cleaning effects in the resumption operations of autonomous apparatuses.

In some embodiments, a method for resuming cleaning after an interruption includes:

in response to detecting an interruption event while an autonomous apparatus executes a cleaning operation on a preset region based on a preset path, acquiring an unexecuted path recorded by the autonomous apparatus at a last periodic recording time point; wherein the periodic recording time point refers to a time point at which the autonomous apparatus periodically updates and records the unexecuted path at a preset time interval while traveling along the preset path;

acquiring an interruption location on the preset path corresponding to the autonomous apparatus when the interruption event was detected; and

after receiving a resumption instruction, controlling the autonomous apparatus to move to a target location and start, from the target location, a first cleaning resumption operation on the preset region based on the unexecuted path, wherein the target location refers to a location coinciding with the interruption location, a location coinciding with a starting point of the unexecuted path, or a location on the preset path located between the interruption location and the starting point of the unexecuted path.

In some embodiments, an autonomous apparatus includes a traveling device, a cleaning device, and a controller, the controller including a memory, a processor, and computer-readable instructions stored in the memory and executable on the processor, wherein when the processor executes the computer-readable instructions, the processor controls the traveling device and the cleaning device to implement the following steps:

in response to detecting an interruption event while the autonomous apparatus executes a cleaning operation on a preset region based on a preset path, acquiring an unexecuted path recorded by the autonomous apparatus at a last periodic recording time point; wherein the periodic recording time point refers to a time point at which the autonomous apparatus periodically updates and records the unexecuted path at a preset time interval while traveling along the preset path;

acquiring an interruption location on the preset path corresponding to the autonomous apparatus when the interruption event was detected; and

in response to receiving a resumption instruction, controlling the autonomous apparatus to move to a target location and execute a first cleaning resumption operation on the preset region starting from the target location based on the unexecuted path; wherein the target location refers to a location coinciding with the interruption location, a location coinciding with a starting point of the unexecuted path, or a location on the preset path located between the interruption location and the starting point of the unexecuted path.

A non-transitory computer-readable storage medium storing computer-executable instructions that, when executed by one or more processors, cause the one or more processors to perform operations comprising:

when an autonomous apparatus executes a cleaning operation on a preset region based on a preset path, if an interruption event is detected, acquiring an unexecuted path recorded by the autonomous apparatus at a last periodic recording time point; wherein the periodic recording time point refers to a time point at which the autonomous apparatus periodically updates and records the unexecuted path at a preset time interval while traveling along the preset path; acquiring an interruption location on the preset path corresponding to the autonomous apparatus when the interruption event was detected; and

after receiving a resumption instruction, controlling the autonomous apparatus to move to a target location and start, from the target location, a first cleaning resumption operation on the preset region based on the unexecuted path; wherein the target location refers to a location coinciding with the interruption location, a location coinciding with a starting point of the unexecuted path, or a location on the preset path located between the interruption location and the starting point of the unexecuted path.

The present disclosure provides a method and apparatus for resuming cleaning after an interruption, an autonomous apparatus, and a storage medium. The method may include: in response to detecting an interruption event while an autonomous apparatus executes a cleaning operation on a preset region based on a preset path, acquiring an unexecuted path recorded by the autonomous apparatus at a most recent periodic recording time point; wherein the periodic recording time point refers to a time point at which the autonomous apparatus periodically updates and records the unexecuted path at a preset time interval while traveling along the preset path; acquiring an interruption location on the preset path corresponding to the autonomous apparatus when the interruption event was detected; and in response to receiving a resumption instruction, controlling the autonomous apparatus to move to a target location and start, from the target location, a first cleaning resumption operation on the preset region based on the unexecuted path; wherein the target location refers to a location coinciding with the interruption location, a location coinciding with a starting point of the unexecuted path, or a location on the preset path located between the interruption location and the starting point of the unexecuted path.

In the present disclosure, the unexecuted path is periodically recorded at a preset time interval. When an interruption event is detected, the corresponding interruption location on the preset path can be determined in real time. Subsequently, a target location can be determined based on the interruption location and the unexecuted path, and a first cleaning resumption operation may be executed on the preset region starting from the target location based on the unexecuted path. This may reduce repeated cleaning of the preset region during the cleaning resumption operation (such as the first cleaning resumption operation), and may reduce the likelihood of missed regions, which may improve the intelligence of the cleaning process, save cleaning time, and enhance cleaning efficiency and effects.

The details of one or more embodiments of the present disclosure are set forth in the accompanying drawings and the description below. Other features and advantages of the present disclosure will be apparent from the specification, the drawings, and the claims.

### BRIEF DESCRIPTION OF DRAWINGS

To more clearly illustrate the technical solutions of the embodiments of the present disclosure, the accompanying drawings required for describing the embodiments will be briefly introduced below. It should be understood that the accompanying drawings in the following description are merely some embodiments of the present disclosure, and those of ordinary skill in the art can obtain other drawings based on these accompanying drawings without creative efforts.

FIG. 1 is a flowchart of a method for resuming cleaning after an interruption according to some embodiments of the present disclosure;

FIG. 2 is a schematic block diagram of an apparatus for resuming cleaning after an interruption according to some embodiments of the present disclosure; and

FIG. 3 is a schematic diagram of a controller according to some embodiments of the present disclosure.

### DETAILED DESCRIPTION

The technical solutions in the embodiments of the present disclosure are described below with reference to the accompanying drawings. It should be understood that the described embodiments are merely some, but not all, of the embodiments of the present disclosure. All other embodiments obtained by those of ordinary skill in the art based on the embodiments of the present disclosure without creative efforts are intended to fall within the protection scope of the present disclosure.

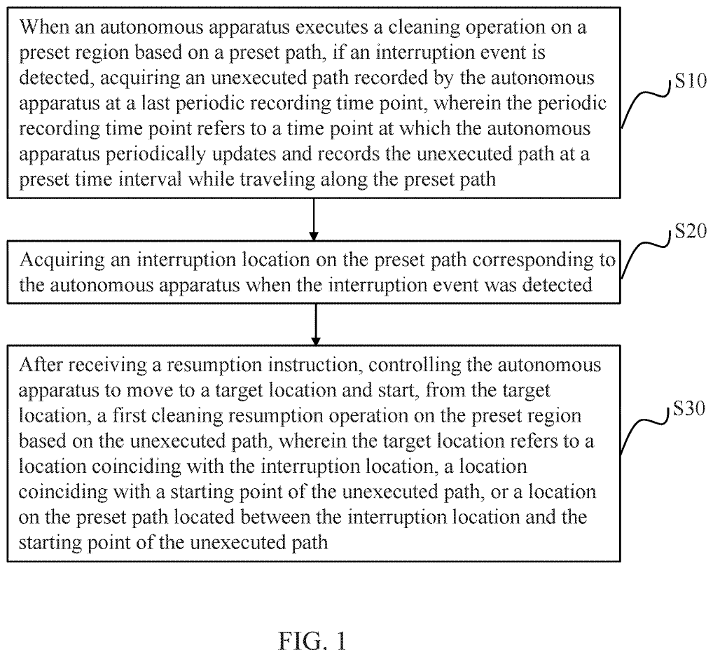

In some embodiments, as shown in FIG. 1, a method for resuming cleaning after an interruption is described, which can be applicable to an autonomous apparatus and may include the following steps:

S10: in response to detecting that an interruption event may be triggered when an autonomous apparatus executes a cleaning operation in a preset region based on a preset path, acquiring an unexecuted path recorded by the autonomous apparatus at a last periodic recording time point, wherein the periodic recording time point may refer to a time point at which the autonomous apparatus periodically updates and records the unexecuted path at a preset time interval while traveling along the preset path.

In some embodiments, the autonomous apparatus may be a mowing device, which can be used for cutting grass on a lawn within a preset region. It should be noted that the mowing device can include at least one cutter used for cutting grass, and at this time, the cleaning operation, the first cleaning resumption operation, the second cleaning resumption operation, the third cleaning resumption operation, the fourth cleaning resumption operation, and the fifth cleaning resumption operation may include mowing operations.

In some embodiments, the autonomous apparatus may be a snow-clearing device. It should be noted that the snow-clearing device may include a snow-rolling motor and a corresponding snow shovel. A snow-rolling blade may be provided in the snow shovel, and the snow-rolling motor may drive the snow shovel to clear snow. At this time, the cleaning operation, the first cleaning resumption operation, the second cleaning resumption operation, the third cleaning resumption operation, the fourth cleaning resumption operation, and the fifth cleaning resumption operation may include snow-clearing operations.

The preset region may refer to a region that is pre-divided and can be cleaned by the autonomous apparatus, and its specific size can be set according to requirements. The preset path may be a path that is, for example, pre-planned for the cleaning operation. For example, when the autonomous apparatus is a snow-clearing device, the snow-clearing device may clear snow according to potential energy levels. The potential energy level may relate to the distance between the autonomous apparatus and a snow-throwing location (the farther the distance, the greater the potential energy for throwing snow) and the direction (the more deviated the direction of the autonomous apparatus relative to the snow-throwing location, the greater the potential energy for throwing snow). Therefore, the preset path may be planned from a high-potential energy region to a low-potential energy region; that is, it may be preferable to plan the preset path to perform snow-throwing processing from the high-potential energy region to the low-potential energy region. When there are multiple sub-regions in one preset region, the snow can be first thrown from one sub-region to another sub-region, and then the snow may be thrown from a final sub-region to the snow-throwing location. In this process, the preset path can be planned according to the relationship between the sub-regions and the snow-throwing location. Specifically, the preset path may be planned to first throw snow from a sub-region farther from the snow-throwing location to a sub-region closer to the snow-throwing location, thereby controlling the autonomous apparatus to travel to the sub-region closer to the snow-throwing location, and controlling the autonomous apparatus to perform snow-throwing processing from the sub-region closer to the snow-throwing location to the snow-throwing location (that is, the preset path may first pass through the sub-region farther from the snow-throwing location, and then pass through the sub-region closer to the snow-throwing location).

Understandably, the preset path may be recorded in an electronic map in advance, thereby facilitating retrieval or display during the cleaning operation. The starting point and end point of the preset path can be set at opposite ends of the preset path. The autonomous apparatus may trigger and start the cleaning operation from the starting point of the preset path, and can end the cleaning operation at the end point of the preset path under continuous normal operation. During the cleaning operation of the autonomous apparatus along the preset path, periodic recording time points may be set at a preset time interval. Accordingly, at each of the above-mentioned periodic recording time points, the unexecuted path may be updated correspondingly, wherein the unexecuted path may belong to a section of the preset path near the end point, the end point of the unexecuted path may coincide with the end point of the preset path, and the starting point of the unexecuted path can be located between the starting point and the end point of the preset path (or may coincide with the starting point or the end point of the preset path).

Understandably, the periodic recording time point may refer to a time point at which the autonomous apparatus periodically updates and records the unexecuted path at a preset time interval (the preset time interval may be set according to requirements, for example, 2s) while traveling along the preset path (that is, during the cleaning operation, the unexecuted path may be updated and recorded at every preset time interval. Specifically, the updated unexecuted path may be written into a preset JSON file for recording at every preset time interval). The unexecuted path in these embodiments may refer to a path segment in the preset path recorded at the most recent periodic recording time point that may not yet be cleaned during the cleaning operation.

S20: acquiring an interruption location on the preset path corresponding to the autonomous apparatus when the interruption event may be triggered. The interruption location may refer to the real-time location on the preset path where the autonomous apparatus may be located when the interruption event may occur. The interruption location may be acquired in real-time through an onboard positioning device during the travel of the autonomous apparatus. The interruption event may include but may not be limited to power failure, malfunction, returning to a charging station due to low battery level, etc. Whether the interruption event is triggered can be determined by the autonomous apparatus itself, and the determination method may not be limited. For example, it may be determined that the interruption event is triggered after confirming that the autonomous apparatus has not advanced within a preset duration, or it may be determined that the interruption event is triggered after confirming that the battery level of the autonomous apparatus may be lower than a preset battery level threshold.

S30: in response to receiving a resumption instruction, controlling the autonomous apparatus to move to a target location and execute a first cleaning resumption operation in the preset region starting from the target location based on the unexecuted path, wherein the target location may refer to a location coinciding with the interruption location, a location coinciding with a starting point of the unexecuted path, or a location on the preset path located between the interruption location and the starting point of the unexecuted path. The resumption instruction may be generated when the autonomous apparatus resumes work and confirms to start continuing to clean the preset region (it may be generated after a preset button on the autonomous apparatus is triggered after the autonomous apparatus resumes work, or after a preset trigger switch on a smart terminal communicatively connected to the autonomous apparatus is triggered), or may be generated when the autonomous apparatus may be charged at a charging station and confirms to start continuing to clean the preset region. In these embodiments, there may be the following possibilities for the target location: first, the target location may coincide with the interruption location; second, the target location may coincide with the starting point of the unexecuted path, or the target location can be located between the interruption location and the starting point of the unexecuted path on the preset path. At this time, the target location may be located ahead of the interruption location (in the present disclosure, “ahead” and “behind” may be determined according to the execution order of the cleaning operation on the preset path; that is, a location on the preset path where the cleaning operation is to be performed earlier may be considered ahead, while a location where the cleaning operation is performed relatively later may be considered behind). Thus, during the process of the autonomous apparatus executing the first cleaning resumption operation in the preset region starting from the target location based on the unexecuted path, it may start from a location where the cleaning operation has already been performed, potentially reducing missed cleaning of the preset region and potentially improving the cleaning effect. Meanwhile, the starting point of the unexecuted path may coincide with or may be located ahead of the target location. Therefore, when the autonomous apparatus executes the first cleaning resumption operation in the preset region starting from the target location based on the unexecuted path, it may not start from a location that is too far ahead (the furthest location ahead may coincide with the starting point of the unexecuted path from the most recent periodic update), thus potentially reducing excessive repeated cleaning, potentially improving cleaning efficiency, and potentially saving cleaning time.

In the method for resuming cleaning after an interruption of the above-mentioned embodiments of the present disclosure, the unexecuted path may be periodically recorded at a preset time interval, and when an interruption event is triggered, the interruption location on the preset path corresponding to the autonomous apparatus when the interruption event is triggered may be determined in real-time. Afterwards, the target location can be determined based on the interruption location and the unexecuted path, and then a first cleaning resumption operation may be executed in the preset region based on the unexecuted path starting from the target location, potentially reducing repeated cleaning of the preset region during the cleaning resumption operation (such as the first cleaning resumption operation), and missed regions may be reduced, which may improve the intelligence level of the cleaning process, potentially save cleaning time, and also enhance cleaning efficiency and effectiveness.

Further, the preset path may include a first path in the preset region and a second path located outside the preset region, and the first path and the second path are connected. The first path may refer to a path corresponding to a cleaning operation in which the autonomous apparatus enables a cleaning function (for example, a snow-clearing device enabling a snow-clearing function to perform a snow-clearing operation, and a mowing device enabling a mowing function to perform a mowing operation), while the second path is a path used for route planning, that is, a path from the starting point of the preset path (such as a charging station) to a boundary location of the preset region, and in the second path, the cleaning function may not be enabled. Understandably, if, as described in step S10, the autonomous apparatus executes a cleaning operation in the preset region along the first path and detects that an interruption event is triggered, the unexecuted path recorded by the autonomous apparatus at the last periodic recording time point can be acquired to proceed to step S20 to acquire the interruption location, and then proceed to the next operation in step S30. If the autonomous apparatus detects that an interruption event is triggered in the second path, the recording of the interruption location may be omitted, and the entire first path can be recorded as a remaining work path, and the intersection of the first path and the second path can be recorded as a work-resumption cleaning location. Afterwards, in response to receiving a resumption instruction, the autonomous apparatus is controlled to move to the work-resumption cleaning location, and a third cleaning resumption operation is executed in the preset region starting from the work-resumption cleaning location based on the remaining work path.

In some embodiments, the unexecuted path includes a preset moving direction and a preset moving route. That is, when recording the unexecuted path, the preset moving direction and the preset moving route in the unexecuted path can be recorded simultaneously, so that when the autonomous apparatus resumes work to perform the first cleaning resumption operation (the preset moving direction and the preset moving route can also be referenced and used in other cleaning resumption operations), it can move directly along the preset moving route in the preset moving direction, potentially reducing problems such as directional deviation. Further, in step S30, controlling the autonomous apparatus to move to the target location and execute the first cleaning resumption operation in the preset region starting from the target location based on the unexecuted path includes:

controlling the autonomous apparatus to move to the target location, adjusting a moving direction of the autonomous apparatus based on the preset moving direction, and executing the first cleaning resumption operation in the preset region starting from the target location based on the preset moving route. That is, after the autonomous apparatus resumes work and receives the resumption instruction, if the autonomous apparatus has been controlled to move to the target location, at this time, since the target location may be located on the unexecuted path (the unexecuted path belongs to a part of the preset path, and the target location is located on or before the interruption location on the preset path, and is located on or after the starting point of the unexecuted path), therefore, the moving direction of the autonomous apparatus can be adjusted in real-time according to the preset moving direction recorded in the unexecuted path, so that the moving direction of the autonomous apparatus matches the preset moving direction corresponding to the unexecuted path during the first cleaning resumption operation (that is, the moving direction of the autonomous apparatus is adjusted in real-time according to the preset moving direction, so that the traveling direction of the autonomous apparatus matches the turning direction of the unexecuted path), and then it can travel directly along the preset moving route, potentially reducing problems such as directional deviation.

In some embodiments, in step S30, controlling the autonomous apparatus to move to the target location and start, from the target location, the first cleaning resumption operation on the preset region based on the unexecuted path includes:

acquiring a current location of the autonomous apparatus from the resumption instruction, and confirming whether the current location coincides with the interruption location. The current location may refer to the real-time location of the autonomous apparatus when it resumes work and receives the resumption instruction. For example, when the autonomous apparatus returns to a charging station for charging due to insufficient battery power and triggers an interruption event, at this time, upon acquiring the resumption instruction, the current location of the autonomous apparatus may be the charging station, or the current location may also be the location where the autonomous apparatus restarts after a shutdown caused by power failure or malfunction.

when the current location does not coincide with the interruption location, determining a first optimal moving path based on the current location, the target location, and the unexecuted path. That is, when the current location does not coincide with the interruption location, a first optimal moving path may be planned first for cleaning the unexecuted path from the current location via the target location. The planning of the first optimal moving path is mainly for the planning of the preceding path from the current location to the target location (which can be set according to distance or time), and the subsequent path starting from the target location can be directly set according to the unexecuted path (since the target location is located on the unexecuted path, the subsequent path starting from the target location is preferably coincident with the unexecuted path). Understandably, when the current location coincides with the interruption location, the autonomous apparatus can be directly controlled to perform a fourth cleaning resumption operation on the preset region from the current location via the target location based on the unexecuted path.

controlling the autonomous apparatus to move from the current location to the target location along the first optimal moving path and then start, from the target location, the first cleaning resumption operation on the preset region along the first optimal moving path. That is, in these embodiments, after arriving at the target location from the current location along the first optimal moving path, the first cleaning resumption operation is executed on the preset region according to the first optimal moving path, which may enable the autonomous apparatus to reach the target location quickly and continue cleaning the preset region, potentially improving cleaning efficiency.

In some embodiments, in step S30, controlling the autonomous apparatus to move to the target location includes:

S301: acquiring a current location of the autonomous apparatus from the resumption instruction, controlling the autonomous apparatus to move from the current location to a redundant starting point, and then controlling the autonomous apparatus to move from the redundant starting point to the target location along the preset path and execute a second cleaning resumption operation on the preset region during movement; wherein the redundant starting point is set on the preset path, and the redundant starting point is located on a side of the target location proximate to a starting point of the preset path. The current location may refer to the real-time location of the autonomous apparatus when it resumes work and receives the resumption instruction. For example, when the autonomous apparatus returns to a charging station for charging due to insufficient battery power and triggers an interruption event, at this time, upon acquiring the resumption instruction, the current location of the autonomous apparatus may be the charging station, or the current location may also be the location where the autonomous apparatus restarts after a shutdown caused by power failure or malfunction.

Understandably, the redundant starting point may refer to a location located before the target location on the preset path (the redundant starting point is equivalent to a location previously traversed by the autonomous apparatus). The redundant starting point can be set according to requirements. For example, it can be set at a preset distance before the target location on the preset path. The preset distance can be set directly as a length (for example, 1 meter), or can be set according to the working duration of the autonomous apparatus, for example, setting the preset distance as the length corresponding to the autonomous apparatus working for 2 seconds under preset cleaning parameters.

Understandably, since the target location may be close to or even coincide with the interruption location corresponding to the triggered interruption event, therefore, if the autonomous apparatus starts working directly from a location close to or coinciding with the interruption location, at this time, due to the autonomous apparatus's own positioning error, if the autonomous apparatus, when positioning the target location, travels to a location that has not been cleaned due to the positioning error, there may be a partially missed cleaning region between this location and the interruption location, thus potentially resulting in poor cleaning effectiveness. Therefore, to potentially reduce the problem of missed cleaning, in these embodiments, the aforementioned redundant starting point is set (at a preset distance before the target location, that is, before the interruption location), and is set such that after receiving the resumption instruction, the autonomous apparatus is first controlled to move from the current location to the redundant starting point, and then the autonomous apparatus is controlled to perform a second cleaning resumption operation on the preset region corresponding to the preset path between the redundant starting point and the target location, thereby potentially avoiding the occurrence of missed cleaning and improving the cleaning effect.

Furthermore, in step S301, controlling the autonomous apparatus to move from the redundant starting point to the target location along the preset path includes:

determining whether the redundant starting point is a turning point on the preset path; That is, the redundant starting point may be located at a turning point on the preset path, where a turning point may refer to a location on the preset path where a sharp turn occurs, and the autonomous apparatus located at the turning point on the preset path may need to adjust its motion direction to continue performing the cleaning operation.

when the redundant starting point is a turning point, acquiring a turning direction corresponding to the redundant starting point, and after adjusting a motion direction of the autonomous apparatus based on the turning direction, controlling the autonomous apparatus to move from the redundant starting point to the target location along the preset path. That is, when the redundant starting point is a turning point, in order to potentially prevent the autonomous apparatus from being unable to quickly determine its travel direction (if the autonomous apparatus performs a turning movement after activating the cleaning function at the turning point, it may not only affect work efficiency but also increase power consumption), the turning direction corresponding to the redundant starting point in the preset path can be determined first, and after adjusting the motion direction of the autonomous apparatus according to the turning direction, the autonomous apparatus is then controlled to perform the second cleaning resumption operation between the redundant starting point and the target location, thereby potentially improving the cleaning efficiency of the autonomous apparatus and reducing power consumption. Understandably, when the redundant starting point is not a turning point, controlling the autonomous apparatus to move from the redundant starting point along the preset path to the target location, and execute the second cleaning resumption operation on the preset region during the movement.

Further, in step S301, controlling the autonomous apparatus to move from the current location to the redundant starting point, and then controlling the autonomous apparatus to move from the redundant starting point to the target location along the preset path and execute the second cleaning resumption operation on the preset region during the movement, further includes:

confirming whether the current location coincides with the interruption location. The current location may refer to the real-time location of the autonomous apparatus when it resumes work and receives the resumption instruction. For example, when the autonomous apparatus returns to a charging station for charging due to insufficient battery power and triggers an interruption event, at this time, upon acquiring the resumption instruction, the current location of the autonomous apparatus may be the charging station.

when the current location does not coincide with the interruption location, determining a second optimal moving path based on the current location, the redundant starting point, the target location, and the unexecuted path. That is, when the current location does not coincide with the interruption location, a second optimal moving path may be planned first that sequentially passes through the redundant starting point and the target location from the current location to clean the unexecuted path. The planning of the second optimal moving path is mainly for the planning of the preceding path from the current location to the target location via the redundant starting point (which can be set according to distance or time), and the subsequent path starting from the target location can be directly set according to the unexecuted path (since the target location is located on the unexecuted path, the subsequent path starting from the target location is preferably coincident with the unexecuted path). Understandably, when the current location coincides with the interruption location, the autonomous apparatus can be directly controlled to perform a fifth cleaning resumption operation in the preset region, starting from the current location and sequentially passing through the redundant starting point and the target location, based on the unexecuted path.

Controlling the autonomous apparatus to move to the redundant starting position along the second optimized moving path, and then controlling the autonomous apparatus to move from the redundant starting position to the target position along the second optimized moving path and execute the second resume-cleaning operation in the preset region during the movement. That is, in these embodiments, after the autonomous apparatus arrives at the redundant starting position from the current position along the second optimized moving path, the second resume-cleaning operation is executed in the preset region according to the second optimized moving path, which enables the autonomous apparatus to reach the redundant starting position at the fastest speed and continue cleaning the preset region located between the redundant starting position and the target position, thus improving cleaning efficiency.

Further, in step S30, executing the first cleaning resumption operation in the preset region starting from the target location based on the unexecuted path includes: controlling the autonomous apparatus to execute the first cleaning resumption operation in the preset region starting from the target location along the second optimal moving path. That is, in these embodiments, after continuing to clean the preset region located between the redundant starting point and the target location according to the second optimal moving path, the autonomous apparatus may also continue to perform the first cleaning resumption operation in the preset region using the second optimal moving path, wherein the portion of the second optimal moving path after the target location is preferably coincident with the unexecuted path.

It should be understood that the sequence numbers of the steps in the above-mentioned embodiments do not imply a strict order of execution; the execution order of each process should be determined by its function and internal logic, and should not constitute any limitation on the implementation process of the embodiments of this technology.

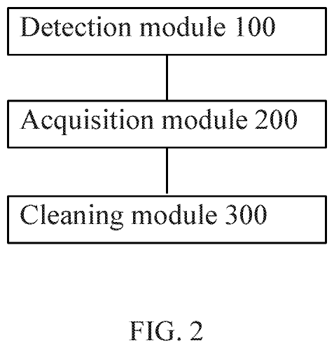

In some embodiments, as shown in FIG. 2, an apparatus for resuming cleaning from an interruption point is provided, and the apparatus corresponds one-to-one with the method for resuming cleaning from an interruption point in the above-mentioned embodiments. The apparatus for resuming cleaning from an interruption point includes:

a detection module 100, configured to, in response to detecting an interruption event while an autonomous apparatus executes a cleaning operation on a preset region based on a preset path, acquire an unexecuted path recorded by the autonomous apparatus at a most recent periodic recording time point, wherein the periodic recording time point may refer to a time point at which the autonomous apparatus periodically updates and records the unexecuted path at a preset time interval while traveling along the preset path;

an acquisition module 200, configured to acquire an interruption location on the preset path corresponding to the autonomous apparatus when the interruption event was detected; and

a cleaning module 300, configured to, in response to receiving a resume-cleaning instruction, control the autonomous apparatus to move to a target position and execute a first resume-cleaning operation in the preset region starting from the target position based on the unexecuted path, wherein the target position refers to a position coinciding with the interruption position, a position coinciding with a starting point of the unexecuted path, or a position on the preset path located between the interruption position and the starting point of the unexecuted path.

With regard to the apparatus for resuming cleaning from an interruption point of this technology, the unexecuted path is periodically recorded at a preset time interval, and when a predetermined interruption event is triggered, a corresponding interruption position on the preset path is determined in real time. Afterwards, a target position can be determined based on the interruption position and the unexecuted path, and then a first resume-cleaning operation is executed in a preset region based on the target position and according to the unexecuted path. This avoids repeated cleaning of the preset region during the resume-cleaning operation (such as the first resume-cleaning operation), and there will be no missed regions, which improves the intelligence of the cleaning process, saves cleaning time, and also greatly improves cleaning efficiency and effectiveness.

Regarding the specific limitations of the apparatus for resuming cleaning from an interruption point, reference can be made to the limitations of the method for resuming cleaning from an interruption point described above, which will not be repeated here. Each module in the aforementioned apparatus for resuming cleaning from an interruption point can be implemented in whole or in part through software, hardware, or a combination thereof. The aforementioned modules can be embedded in a processor of a computer device in hardware form or be independent of it, or can be stored in a memory of the computer device in software form, so that the processor calls and executes the operations corresponding to each module.

In some embodiments, a autonomous apparatus is provided, including a traveling device, a cleaning device, and a controller. The controller includes a memory, a processor, and computer-readable instructions stored in the memory and executable on the processor. When the processor executes the computer-readable instructions, it controls the traveling device and the cleaning device to implement the aforementioned method for resuming cleaning from an interruption point.

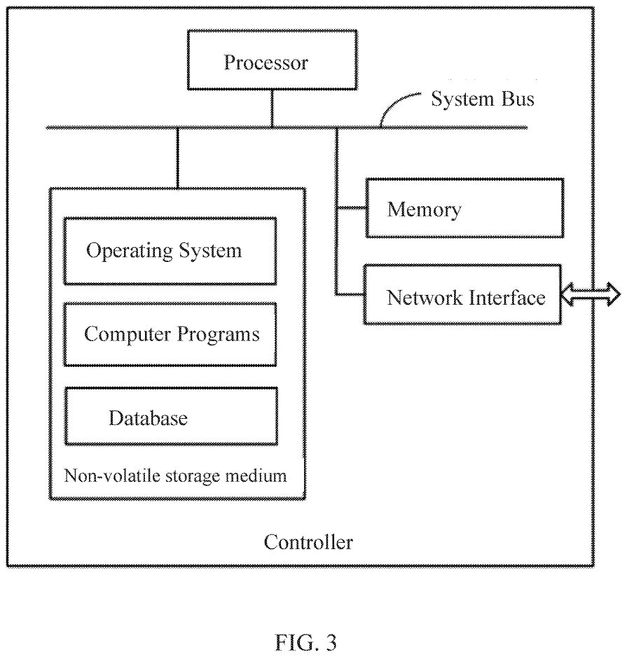

The internal structure diagram of the aforementioned controller can be as shown in FIG. 3. The controller includes a processor, a memory, a network interface, and a database connected by a system bus. The processor of the controller is configured to provide computing and control capabilities. The memory of the controller includes a non-volatile storage medium and an internal memory. The non-volatile storage medium stores an operating system, computer-readable instructions, and a database. The internal memory provides an environment for the operation of the operating system and computer-readable instructions in the non-volatile storage medium. When the computer-readable instructions are executed by the processor, the aforementioned method for resuming cleaning from an interruption point is implemented.

In some embodiments, the autonomous apparatus is a grass-cutting device, which is used for cutting grass on a lawn within a preset region (at this time, the cleaning operation, the first resume-cleaning operation, and the second resume-cleaning operation are all grass-cutting operations).

In some embodiments, the autonomous apparatus is a snow-clearing device. It should be noted that the snow-clearing device includes a snow-rolling motor and a corresponding snow shovel. A snow-rolling blade is provided in the snow shovel, and the snow-rolling motor drives the snow shovel to clear snow (at this time, the cleaning operation, the first resume-cleaning operation, and the second resume-cleaning operation are all snow-clearing operations).

Regarding the specific limitations of the controller, reference can be made to the limitations of the method for resuming cleaning from an interruption point described above, which will not be repeated here. Each module in the aforementioned controller can be implemented in whole or in part through software, hardware, or a combination thereof. The aforementioned modules can be embedded in a processor of the controller in hardware form or be independent of it, or can be stored in a memory of the controller in software form, so that the processor calls and executes the operations corresponding to each module.

In some embodiments, one or more readable storage media storing computer-readable instructions are provided. The readable storage media provided in these embodiments include non-volatile readable storage media and volatile readable storage media; the readable storage media store computer-readable instructions, and when the computer-readable instructions are executed by one or more processors, they cause the one or more processors to implement the steps of the aforementioned method for resuming cleaning from an interruption point.

Those of ordinary skill in the art can understand that all or part of the processes in the methods of the aforementioned embodiments can be implemented by instructing relevant hardware through computer-readable instructions. The computer-readable instructions can be stored in a non-volatile computer-readable storage medium or a volatile readable storage medium. When executed, the computer-readable instructions can include the processes of the embodiments of the aforementioned methods. Any reference to a memory, a storage, a database, or other medium used in the embodiments provided by this disclosure can include a non-volatile and/or volatile memory. The non-volatile memory can include Read-Only Memory (ROM), Programmable ROM (PROM), Erasable Programmable ROM (EPROM), Electrically Erasable Programmable ROM (EEPROM), or flash memory. The volatile memory can include Random Access Memory (RAM) or external cache memory. By way of illustration and not limitation, RAM is available in many forms, such as Static RAM (SRAM), Dynamic RAM (DRAM), Synchronous DRAM (SDRAM), Double Data Rate SDRAM (DDRSDRAM), Enhanced SDRAM (ESDRAM), Synchronous Link DRAM (SLDRAM), Rambus Direct RAM (RDRAM), Direct Rambus Dynamic RAM (DRDRAM), and Rambus Dynamic RAM (RDRAM), etc.

Those skilled in the art can clearly understand that, for the convenience and brevity of description, the division of the functional units or modules is only used as an example. In practical applications, the functions can be assigned to different functional units or modules as needed; that is, the internal structure of the device is divided into different functional units or modules to complete all or part of the functions described above.

The embodiments described above are only used to illustrate the technical solutions of this technology, not to limit them. Although this disclosure has been described in detail with reference to the foregoing embodiments, those of ordinary skill in the art should understand that they can still modify the technical solutions described in the foregoing embodiments, or equivalently replace some of the technical features. These modifications or replacements do not cause the essence of the corresponding technical solutions to depart from the spirit and scope of the technical solutions of the embodiments of this technology, and should all be included within the protection scope of this disclosure.

1-20. (canceled)

21. A method for resuming cleaning after an interruption, the method performed by an autonomous apparatus including a processor, a memory, a traveling device, and a cleaning device, the method comprising:
detecting, by the processor, an interruption event while the autonomous apparatus executes a cleaning operation on a preset region based on a preset path;
acquiring, by the processor from the memory, an unexecuted path recorded at a most recent periodic recording time point of a plurality of periodic recording time points, wherein the processor periodically updates and records the unexecuted path in the memory at a preset time interval to establish the plurality of periodic recording time points while the autonomous apparatus travels along the preset path;
determining, by the processor, an interruption location on the preset path corresponding to a physical location of the autonomous apparatus when the interruption event was detected; and
in response to receiving a resumption instruction, controlling, by the processor, the traveling device to navigate the autonomous apparatus to a target location and controlling the cleaning device to start, from the target location, a first cleaning resumption operation on the preset region based on the unexecuted path, wherein the target location is a location coinciding with the interruption location, a location coinciding with a starting point of the unexecuted path, or a location on the preset path located between the interruption location and the starting point of the unexecuted path.

22. The method of claim 21, wherein:
the unexecuted path includes a preset moving direction and a preset moving route; and
controlling the traveling device to navigate the autonomous apparatus to the target location and controlling the cleaning device to start, from the target location, the first cleaning resumption operation on the preset region based on the unexecuted path includes:
controlling, by the processor, the traveling device to navigate the autonomous apparatus to the target location;
controlling, by the processor, the traveling device to adjust a motion direction of the autonomous apparatus based on the preset moving direction; and
controlling, by the processor, the cleaning device to start, from the target location, the first cleaning resumption operation on the preset region based on the preset moving route.

23. The method of claim 21, wherein controlling the traveling device to navigate the autonomous apparatus to the target location and controlling the cleaning device to start, from the target location, the first cleaning resumption operation on the preset region based on the unexecuted path includes:
determining, by the processor, a current location of the autonomous apparatus from the resumption instruction;
determining, by the processor, whether the current location coincides with the interruption location;
in response to determining that the current location does not coincide with the interruption location, determining, by the processor, a first optimal moving path based on the current location, the target location, and the unexecuted path;
controlling, by the processor, the traveling device to navigate the autonomous apparatus from the current location to the target location along the first optimal moving path; and
controlling, by the processor, the cleaning device to start, from the target location, the first cleaning resumption operation on the preset region along the first optimal moving path.

24. The method of claim 21, wherein controlling the traveling device to navigate the autonomous apparatus to the target location includes:
determining, by the processor, a current location of the autonomous apparatus from the resumption instruction;
controlling, by the processor, the traveling device to navigate the autonomous apparatus from the current location to a redundant starting point; and
controlling, by the processor, the traveling device to navigate the autonomous apparatus from the redundant starting point to the target location along the preset path and controlling the cleaning device to execute a second cleaning resumption operation on the preset region during movement from the redundant starting point to the target location, wherein:
the redundant starting point is located on the preset path, and
the redundant starting point is located between a starting point of the preset path and the target location.

25. The method of claim 24, wherein controlling the traveling device to navigate the autonomous apparatus from the redundant starting point to the target location along the preset path includes:
determining, by the processor, whether the redundant starting point is a turning point on the preset path; and
in response to determining that the redundant starting point is the turning point:
acquiring, by the processor, a turning direction corresponding to the redundant starting point;
controlling, by the processor, the traveling device to adjust a motion direction of the autonomous apparatus based on the turning direction; and
controlling, by the processor, the traveling device to navigate the autonomous apparatus from the redundant starting point to the target location along the preset path.

26. The method of claim 24, wherein controlling the traveling device to navigate the autonomous apparatus from the redundant starting point to the target location along the preset path includes:
determining, by the processor, whether the redundant starting point is a turning point on the preset path; and
in response to determining that the redundant starting point is not the turning point:
controlling, by the processor, the traveling device to navigate the autonomous apparatus from the redundant starting point to the target location along the preset path; and
controlling, by the processor, the cleaning device to execute the second cleaning resumption operation on the preset region during the movement from the redundant starting point to the target location.

27. The method of claim 24, further comprising:
determining, by the processor, whether the current location coincides with the interruption location; and
in response to determining that the current location does not coincide with the interruption location, determining, by the processor, a second optimal moving path based on the current location, the redundant starting point, the target location, and the unexecuted path, wherein:
controlling, by the processor, the traveling device to navigate the autonomous apparatus from the current location to the redundant starting point includes controlling, by the processor, the traveling device to navigate the autonomous apparatus to the redundant starting point along the second optimal moving path;
controlling, by the processor, the traveling device to navigate the autonomous apparatus from the redundant starting point to the target location along the preset path includes controlling, by the processor, the traveling device to navigate the autonomous apparatus from the redundant starting point to the target location along the second optimal moving path; and
controlling, by the processor, the cleaning device to start, from the target location, the first cleaning resumption operation on the preset region based on the unexecuted path includes controlling, by the processor, the cleaning device to start, from the target location, the first cleaning resumption operation on the preset region along the second optimal moving path.

28. An autonomous apparatus, comprising:
a traveling device;
a cleaning device; and
a controller, the controller including a memory, a processor, and computer-readable instructions stored in the memory and executable on the processor, wherein when the processor executes the computer-readable instructions, the processor controls the traveling device and the cleaning device to implement steps including:
detecting, by the processor, an interruption event while the autonomous apparatus executes a cleaning operation on a preset region based on a preset path;
acquiring, by the processor from the memory, an unexecuted path recorded at a most recent periodic recording time point of a plurality of periodic recording time points, wherein the processor periodically updates and records the unexecuted path in the memory at a preset time interval to establish the plurality of periodic recording time points while the autonomous apparatus travels along the preset path;
determining, by the processor, an interruption location on the preset path corresponding to a physical location of the autonomous apparatus when the interruption event was detected; and
in response to receiving a resumption instruction, controlling, by the processor, the traveling device to navigate the autonomous apparatus to a target location and controlling the cleaning device to start, from the target location, a first cleaning resumption operation on the preset region based on the unexecuted path, wherein the target location is a location coinciding with the interruption location, a location coinciding with a starting point of the unexecuted path, or a location on the preset path located between the interruption location and the starting point of the unexecuted path.

29. The autonomous apparatus of claim 28, wherein:
the unexecuted path includes a preset moving direction and a preset moving route; and
controlling the traveling device to navigate the autonomous apparatus to the target location and controlling the cleaning device to start, from the target location, the first cleaning resumption operation on the preset region based on the unexecuted path includes:
controlling, by the processor, the traveling device to navigate the autonomous apparatus to the target location;
controlling, by the processor, the traveling device to adjust a motion direction of the autonomous apparatus based on the preset moving direction; and
controlling, by the processor, the cleaning device to start, from the target location, the first cleaning resumption operation on the preset region based on the preset moving route.

30. The autonomous apparatus of claim 28, wherein controlling the traveling device to navigate the autonomous apparatus to the target location and controlling the cleaning device to start, from the target location, the first cleaning resumption operation on the preset region based on the unexecuted path includes:
determining, by the processor, a current location of the autonomous apparatus from the resumption instruction;
determining, by the processor, whether the current location coincides with the interruption location;
in response to determining that the current location does not coincide with the interruption location, determining, by the processor, a first optimal moving path based on the current location, the target location, and the unexecuted path;
controlling, by the processor, the traveling device to navigate the autonomous apparatus from the current location to the target location along the first optimal moving path; and
controlling, by the processor, the cleaning device to start, from the target location, the first cleaning resumption operation on the preset region along the first optimal moving path.

31. The autonomous apparatus of claim 28, wherein controlling the traveling device to navigate the autonomous apparatus to the target location includes:
determining, by the processor, a current location of the autonomous apparatus from the resumption instruction;
controlling, by the processor, the traveling device to navigate the autonomous apparatus from the current location to a redundant starting point; and
controlling, by the processor, the traveling device to navigate the autonomous apparatus from the redundant starting point to the target location along the preset path and controlling the cleaning device to execute a second cleaning resumption operation on the preset region during movement from the redundant starting point to the target location, wherein:
the redundant starting point is located on the preset path; and
the redundant starting point is located between a starting point of the preset path and the target location.

32. The autonomous apparatus of claim 31, wherein controlling the traveling device to navigate the autonomous apparatus from the redundant starting point to the target location along the preset path includes:
determining, by the processor, whether the redundant starting point is a turning point on the preset path; and
in response to determining that the redundant starting point is the turning point:
acquiring, by the processor, a turning direction corresponding to the redundant starting point,
controlling, by the processor, the traveling device to adjust a motion direction of the autonomous apparatus based on the turning direction, and
controlling, by the processor, the traveling device to navigate the autonomous apparatus from the redundant starting point to the target location along the preset path.

33. The autonomous apparatus of claim 31, wherein the implemented steps further comprise:
determining, by the processor, whether the current location coincides with the interruption location; and
in response to determining that the current location does not coincide with the interruption location, determining, by the processor, a second optimal moving path based on the current location, the redundant starting point, the target location, and the unexecuted path, wherein:
controlling, by the processor, the traveling device to navigate the autonomous apparatus from the current location to the redundant starting point includes controlling, by the processor, the traveling device to navigate the autonomous apparatus to the redundant starting point along the second optimal moving path;
controlling, by the processor, the traveling device to navigate the autonomous apparatus from the redundant starting point to the target location along the preset path includes controlling, by the processor, the traveling device to navigate the autonomous apparatus from the redundant starting point to the target location along the second optimal moving path; and
controlling, by the processor, the cleaning device to start, from the target location, the first cleaning resumption operation on the preset region based on the unexecuted path includes controlling, by the processor, the cleaning device to start, from the target location, the first cleaning resumption operation on the preset region along the second optimal moving path.

34. The autonomous apparatus of claim 28, wherein the cleaning device is a snow-clearing device, a grass-cutting device, or a leaf-blowing device.

35. A non-transitory computer-readable storage medium storing computer-executable instructions that, when executed by a processor of an autonomous apparatus including a memory, a traveling device, and a cleaning device, cause the processor to perform operations comprising:
detecting, by the processor, an interruption event while the autonomous apparatus executes a cleaning operation on a preset region based on a preset path;
acquiring, by the processor from the memory, an unexecuted path recorded at a most recent periodic recording time point of a plurality of periodic recording time points, wherein the processor periodically updates and records the unexecuted path in the memory at a preset time interval to establish the plurality of periodic recording time points while the autonomous apparatus travels along the preset path;
determining, by the processor, an interruption location on the preset path corresponding to a physical location of the autonomous apparatus when the interruption event was detected; and
in response to receiving a resumption instruction, controlling, by the processor, the traveling device to navigate the autonomous apparatus to a target location and controlling the cleaning device to start, from the target location, a first cleaning resumption operation on the preset region based on the unexecuted path, wherein the target location is a location coinciding with the interruption location, a location coinciding with a starting point of the unexecuted path, or a location on the preset path located between the interruption location and the starting point of the unexecuted path.

36. The non-transitory computer-readable storage medium of claim 35, wherein:
the unexecuted path includes a preset moving direction and a preset moving route; and
controlling the traveling device to navigate the autonomous apparatus to the target location and controlling the cleaning device to start, from the target location, the first cleaning resumption operation on the preset region based on the unexecuted path includes:
controlling, by the processor, the traveling device to navigate the autonomous apparatus to the target location;
controlling, by the processor, the traveling device to adjust a motion direction of the autonomous apparatus based on the preset moving direction; and
controlling, by the processor, the cleaning device to start, from the target location, the first cleaning resumption operation on the preset region based on the preset moving route.

37. The non-transitory computer-readable storage medium of claim 35, wherein controlling the traveling device to navigate the autonomous apparatus to the target location and controlling the cleaning device to start, from the target location, the first cleaning resumption operation on the preset region based on the unexecuted path includes:
determining, by the processor, a current location of the autonomous apparatus from the resumption instruction;
determining, by the processor, whether the current location coincides with the interruption location;
in response to determining that the current location does not coincide with the interruption location, determining, by the processor, a first optimal moving path based on the current location, the target location, and the unexecuted path;
controlling, by the processor, the traveling device to navigate the autonomous apparatus from the current location to the target location along the first optimal moving path; and
controlling, by the processor, the cleaning device to start, from the target location, the first cleaning resumption operation on the preset region along the first optimal moving path.

38. The non-transitory computer-readable storage medium of claim 35, wherein controlling the traveling device to navigate the autonomous apparatus to the target location includes:
determining, by the processor, a current location of the autonomous apparatus from the resumption instruction;
controlling, by the processor, the traveling device to navigate the autonomous apparatus from the current location to a redundant starting point; and
controlling, by the processor, the traveling device to navigate the autonomous apparatus from the redundant starting point to the target location along the preset path and controlling the cleaning device to execute a second cleaning resumption operation on the preset region during movement from the redundant starting point to the target location, wherein:
the redundant starting point is located on the preset path; and
the redundant starting point is located between a starting point of the preset path and the target location.

39. The non-transitory computer-readable storage medium of claim 38, wherein controlling the traveling device to navigate the autonomous apparatus from the redundant starting point to the target location along the preset path includes:
determining, by the processor, whether the redundant starting point is a turning point on the preset path; and
in response to determining that the redundant starting point is the turning point:
acquiring, by the processor, a turning direction corresponding to the redundant starting point,
controlling, by the processor, the traveling device to adjust a motion direction of the autonomous apparatus based on the turning direction, and
controlling, by the processor, the traveling device to navigate the autonomous apparatus from the redundant starting point to the target location along the preset path.

40. The non-transitory computer-readable storage medium of claim 38, wherein the operations further comprise:
determining, by the processor, whether the current location coincides with the interruption location; and
in response to determining that the current location does not coincide with the interruption location, determining, by the processor, a second optimal moving path based on the current location, the redundant starting point, the target location, and the unexecuted path, wherein:
controlling, by the processor, the traveling device to navigate the autonomous apparatus from the current location to the redundant starting point includes controlling, by the processor, the traveling device to navigate the autonomous apparatus to the redundant starting point along the second optimal moving path;
controlling, by the processor, the traveling device to navigate the autonomous apparatus from the redundant starting point to the target location along the preset path includes controlling, by the processor, the traveling device to navigate the autonomous apparatus from the redundant starting point to the target location along the second optimal moving path; and
controlling, by the processor, the cleaning device to start, from the target location, the first cleaning resumption operation on the preset region based on the unexecuted path includes controlling, by the processor, the cleaning device to start, from the target location, the first cleaning resumption operation on the preset region along the second optimal moving path.
